(19) United States
(12) Patent Application Publication
(10) Pub. No.: US 2016/0239491 A1
(43) Pub. Date: Aug. 18, 2016

(54) DATA EXCHANGE BETWEEN MULTIPLE SOURCING DEVICES

(71) Applicant: EMPIRE TECHNOLOGY DEVELOPMENT LLC, Wilmington, DE (US)

(72) Inventor: Seungil KIM, Seoul (KR)

(21) Appl. No.: 14/384,962

(22) PCT Filed: Jan. 27, 2014
(86) PCT No.: PCT/US14/13161

§ 371 Date: Sep. 12, 2014

(51) Int. Cl. G06F 17/30; H04L 29/08

(52) U.S. Cl. CPC G06F 17/3053; H04L 67/10; H04L 67/06; G06F 17/30247

(57) ABSTRACT

A method performed under control of a first device may include receiving a first photo from a second device; extracting information regarding the first photo; selecting a second photo that is associated with the extracted information from among a plurality of photos; and making the second photo accessible to the second device.

### BACKGROUND

Digital data technologies continue to enhance our use of digital data, such as digital photos and videos, by making them easy to store, access, and share. As digital devices (e.g., smart phones, digital cameras or smart televisions) become more affordable and the digital data becomes more popular, more users will want to share the digital data.

### SUMMARY

In an example, a method performed under control of a first device may include receiving a first photo from a second device; extracting information regarding the first photo; selecting a second photo that is associated with the extracted information from among a plurality of photos; and making the second photo accessible to the second device.

In another example, a photo exchange apparatus may include a photo receiver configured to receive a photo from an end device; a photo manager configured to: extract data corresponding to the received photo, and select a second photo to which the extracted data corresponds; and a photo transmitter configured to transmit the second photo to the end device.

In yet another example, a computer-readable storage medium may store thereon computer-executable instructions that, in response to execution, cause a device to perform operations including receiving first data from an end device; extracting information regarding the first data; selecting second data that is associated with the extracted information; and transmitting the second data to the end device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. With the understanding that these drawings depict only several embodiments in accordance with the disclosure and are, therefore, not to be considered limiting of its scope, the disclosure will be described with additional specificity and detail through use of the accompanying drawings, in which:

FIG. 1 shows an example of a system in which multiple devices and a cloud datacenter may implement data exchange among multiple sourcing devices, arranged in accordance with at least some embodiments described herein;

FIG. 2 shows a block diagram of an example architecture for a device that may implement at least portions of a data exchange, arranged in accordance with at least some embodiments described herein;

FIG. 3 shows a block diagram of another example architecture for a device that may implement at least portions of a data exchange, arranged in accordance with at least some embodiments described herein;

FIG. 4 shows a block diagram of an example architecture for a photo exchange manager that may implement at least portions of a data exchange, arranged in accordance with at least some embodiments described herein;

FIG. 5 shows an example flow of a process for exchanging photos between multiple sourcing devices, arranged in accordance with at least some embodiments described herein;

FIG. 6 illustrates computer program products that may be utilized to provide a scheme for exchanging data between multiple sourcing devices, arranged in accordance with at least some embodiments described herein; and

FIG. 7 is a block diagram illustrating an example computing device that may be utilized to provide a scheme for exchanging data, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatuses, systems, devices, and computer program products related to a data exchange between multiple sourcing devices. Technologies are generally described for an apparatus that may select first data which is associated with second data received from another apparatus. The apparatus may transmit the selected first data to the other apparatus.

In some examples, a first device may be configured to receive a first photo from a second device via a network (e.g., Bluetooth between the first device and the second device). The first device may be further configured to extract information regarding the first photo from the first photo itself or from a tag of the first photo, which may accompany the first photo. For example, the first device may be configured to recognize an object (e.g., a facial image of a person) that appears in the first photo.

Further, the first device may be configured to select a second photo that is associated with the extracted information regarding the first photo from among multiple photos that may be stored in a local database corresponding to the first device, in a cloud datacenter which may be communicatively coupled to the first device, etc. For example, the first device may be configured to calculate a similarity between the recognized object in the first photo and objects in any of the stored multiple photos. Then, the first device may be configured to determine and select the second photo to be transmitted to the second device, automatically, when the calculated similarity is larger than a predetermined value. That is, the second photo may be identified and/or selected as the one of the multiple photos for which a corresponding object may be calculated as having the highest similarity rating or score relative to the recognized object from the first photo. Further, the first device may be configured to transmit the selected second photo to the second device which transmitted the first photo to the first device.

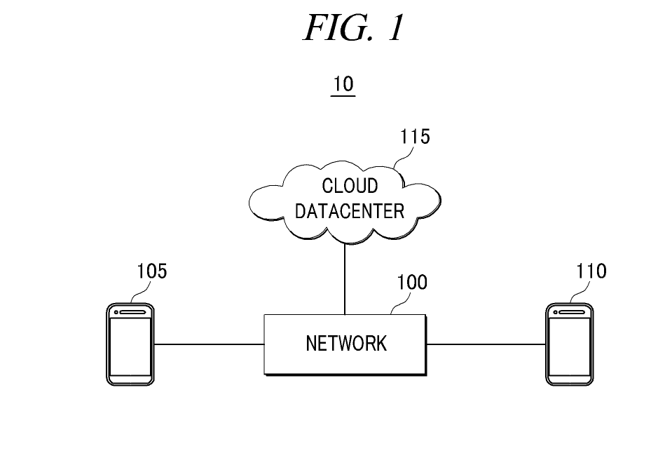

FIG. 1 shows an example of a system in which multiple devices and a cloud datacenter 115 may implement data exchange among multiple sourcing devices, arranged in accordance with at least some embodiments described herein.

Network 100 may refer to a component or module that may be configured to communicatively couple at least two or more of a first device 105, a second device 110, and cloud datacenter 115. Non-limiting examples of network 100 may include a wired network such as a LAN (Local Area Network), a WAN (Wide Area Network), a VAN (Value Added Network) or the like, or various other wireless networks such as a mobile radio communication network including at least one of a 3rd generation (3G) mobile telecommunications network, a 4th or 5th generation mobile telecommunications network, various other mobile telecommunications networks, a satellite network, WiBro (Wireless Broadband Internet), Mobile WiMAX, HSDPA (High Speed Downlink Packet Access), or the like. Alternatively, network 100 may include at least one of a near field communication (NFC), Bluetooth, or peer to peer (P2P) communication protocol.

Each of first device 105 and second device 110 may refer to a device or an apparatus that may be configured to exchange data (e.g., a photo, a video file or an audio file) with each other or with other devices or apparatuses, in accordance with at least some of the embodiments described herein. Respective one of first device 105 and second device 110 may refer to a notebook computer, a personal computer, a mobile phone, a smart phone, a smart television, a digital camera, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminal. In some embodiments, at least one of first device 105 or second device 110 may refer to a cloud datacenter that is configured to receive, store and transmit data (e.g., a photo, a video file or an audio file) associated with a personal device.

In some embodiments, first device 105 may be configured to receive first data from second device 110. As a non-limiting example, the first data may include at least one of a photo, a video file, or an audio file that may be generated by second device 110. Alternatively, the first data may be transmitted from other devices to second device 110, stored on or by second device 110, and then received by first device 105 from second device 110.

In some embodiments, the first data may be accompanied by metadata that corresponds to the first data received from second device 110. For example, but not as a limitation, the metadata corresponding to the first data may refer to a tag of a photo, a video file, or an audio file. As a non-limiting example, the metadata corresponding to the first data may include at least one of a time at which the first data was generated by second device 110, a location at which the first data was generated by second device 110, etc. For example, the metadata regarding the location at which the first data was generated by second device 110 may include coordinates of the location at which the first data was generated. The coordinates of the location may be estimated by a GPS (global positioning system) coupled to second device 110. Additionally and/or alternatively, the metadata regarding the location at which the first data was generated by second device 110 may include an identifier (e.g., a name) of the location at which the first data was generated. Further, as referenced herein, a tag of a photo, a video file, or an audio file may include data that provides information about one or more aspects of the photo, video file, or audio, such as means of creation, location of creation, time and date of creation, a creator or author, etc.

First device 105 may be configured to extract information regarding the first data received from second device 110. Non-limiting examples of the information regarding the first data may include a time at which the first data was generated, a location at which the first data was generated and images of objects in the first data. In some embodiments, first device 105 may be configured to extract the information regarding the first data based on the received metadata that corresponds to the first data. For example, but not as a limitation, first device 105 may be configured to extract and obtain information regarding the time at which the first data was generated by second device 110, the location at which the first data was generated by second device 110, etc.

In some other embodiments, first device 105 may be configured to recognize an object included in the first data. For example, first device 105 may be configured to identify and/or recognize an identity of an object that appears in a photo or video content received from second device 110, by using any well-known object recognition schemes. First device 105 may be configured to then extract and obtain information regarding the recognized object included in the first data. For example, the information regarding the recognized object may include an image of the recognized object, a unique identifier assigned to the recognized object, etc. As non-limiting examples, the recognized object that appears in a photo or video content received from second device 110 may include a face of a person.

First device 105 may be configured to select second data that is associated with the extracted information regarding the first data. As a non-limiting example, the second data may include at least one of a photo, a video file, or an audio file. The second data may be generated by first device 105. Alternatively, the second data may be transmitted from other devices to first device 105 and stored on or by first device 105. Plural data including the second data may be stored in a storage that is associated with first device 105. In some embodiments, the plural data including the second data may be stored in a local database corresponding to first device 105. Further, first device 105 may be configured to select the second data associated with the extracted information regarding the first data from the local database. Alternatively, plural data including the second data may be stored in cloud datacenter 115. Further, first device 105 may be configured to receive, from cloud datacenter 115, the second data associated with the extracted information regarding the first data.

Cloud datacenter 115 may refer to one or more servers or other apparatuses that may be configured to receive data from first device 105 and second device 110 and to transmit data to first device 105 and second device 110. As non-limiting examples, cloud datacenter 115 may be hosted on one or more of an Internet service provider (ISP); application service provider (ASP); and storage service provider (SSP).

In some embodiments, first device 105 may be configured to identify a time at which the second data was generated or a location at which the second data was generated by first device 110 based on metadata regarding the second data. Further, the metadata regarding the second data may be stored in the local database of first device 105 or cloud datacenter 115.

First device 105 may be further configured to calculate a time difference between the time at which the first data was generated by second device 110 and the time at which the second data was generated by first device 105. Further, first device 105 may be configured to determine a correspondence between the first data and the second data based on the calculated time difference. First device 105 may be configured to select the second data that is associated with the extracted information regarding the first data, based at least in part on the calculated time difference. For example, first device 105 may be configured to determine whether the calculated time difference is within a predetermined time value stored in a memory of first device 105. First device 105 may be configured to then select the second data, when the calculated time difference is determined to be within the predetermined time value. For example, first device 105 may be configured to select the second data, if first device 105 determines that the first data (e.g., a first photo) and the second data (e.g., a second photo) are generated within one day or one week.

In some other embodiments, first device 105 may be configured to identify the location at which the second data was generated by first device 105, based on the metadata regarding the second data. For example, the metadata regarding the second data may include coordinates of the location at which the second data was generated by first device 105. For example, the coordinates of the location may be estimated by a GPS (global positioning system) coupled to first device 105. For another example, the metadata regarding the second data may include an identifier (e.g., a name) of the location at which the second data was generated. First device 105 may be further configured to calculate a distance difference between the location at which the first data was generated by second device 110 and the location at which the second data was generated by first device 105. For example, first device 105 may be configured to calculate the distance difference based on the coordinates of the location at which the second data was generated by first device 110 and the coordinates of the location at which the first data was generated by second device 110 in kilometers, and to determine how far away each of the first data and second data was generated. For another example, first device 105 may be configured to identify the identifier (e.g., a name) of the location at which the second data was generated and the identifier (e.g., a name) of the location at which the first data was generated. Further, first device 105 may be configured to compare the two identifiers and to determine whether the first data and the second data were generated at the same place, based on the comparison.

Further, first device 105 may be configured to determine a correspondence between the first data and the second data based on the calculated distance difference. First device 105 may be configured to select the second data that is associated with the extracted information regarding the first data, based at least in part on the calculated distance difference. For example, first device 105 may be configured to determine whether the calculated distance difference is within a predetermined distance stored in a memory of first device 105. First device 105 may be configured to then select the second data, when the calculated distance difference is determined to be within the predetermined distance. For example, first device 105 may be configured to select the second data, if first device 105 determines that the first data (e.g., a first photo) and the second data (e.g., a second photo) are generated at the same place.

In some other embodiments, first device 105 may be configured to identify an object included in the second data by using any well-known object recognition schemes. Further, first device 105 may be configured to determine a correspondence between the first data and the second data based on the identified object and the extracted information regarding the recognized object included in the first data. For example, first device 105 may be configured to calculate a similarity between the recognized object in the first data and the identified object included in the second data. Further, first device 105 may be configured to determine the correspondence between the first data and the second data based on the calculated similarity. First device 105 may be configured to select the second data that is associated with the extracted information regarding the first data, based at least in part on the calculated similarity. For example, first device 105 may be configured to determine whether the calculated similarity is greater than a predetermined value stored in a memory of first device 105. First device 105 may be configured to then select the second data, when the calculated similarity is determined to be greater than the predetermined value. For example, first device 105 may be configured to select the second data, if first device 105 determines that the first data (e.g., a first photo) and the second data (e.g., a second photo) include the same object.

In some other embodiments, first device 105 may be configured to calculate a similarity between the recognized facial image of the person in the first data and a facial image of a person included in the second data. Further, first device 105 may be configured to select the second data that is associated with the extracted information regarding the first data, based at least in part on the calculated similarity. For example, first device 105 may be configured to determine whether the calculated similarity is greater than a predetermined value stored in a memory of first device 105. First device 105 may be configured to then select the second data, when the calculated similarity is determined to be greater than the predetermined value. For example, first device 105 may be configured to select the second data, if first device 105 determines that a same person appears in both of the first data (e.g., a first photo) and the second data (e.g., a second photo).

First device 105 may be configured to make the selected second data accessible to second device 110. In some embodiments, first device 105 may make the selected second data accessible to second device 110 by transmitting the selected second data to second device 110 from which first device 105 received the first data. For example, first device 105 may be configured to transmit to second device 110, at least one of a photo, a video file, or an audio file that is relevant to the photo, video file or audio file received from second device 110, based on the aforementioned calculations and determinations. In some other embodiments, first device 105 make the selected second data accessible to second device 110 by transmitting the selected second data to a storage that is associated with second device 110. For example, the storage associated with second device 110 may be a local storage of second device 110. Alternatively, the storage associated with second device 110 may be a cloud datacenter (e.g., cloud datacenter 115) which may be communicatively coupled to second device 110.

Further, in some embodiments, first device 105 may be configured to receive, from a user of first device 105 via a user interface displayed on first device 105, an input to control at least one of the selecting of the second data or the transmitting of the second data. For example, but not as a limitation, first device 105 may be configured to receive an input to determine whether to activate or deactivate functions to select and transmit the second data.

Further, in some other embodiments, first device 105 may be configured to activate or deactivate functions to select and transmit the second data, based at least in part on second device 110. For example, but not as a limitation, identification information of second device 110 may be pre-registered on or with first device 105. First device 105 may be configured to then select and transmit, to pre-registered second device 110, the second data that is associated with the first data automatically.

Further, in some other embodiments, first device 105 may be configured to activate or deactivate functions to select and transmit the second data, based at least in part on at least one of types of the first data and second data or objects in the first data and second data. For example, but not as a limitation, a type (e.g., a photo, a video or an audio) of the second data to be transmitted from first device 105 to second device 110 may be pre-registered on or with first device 105. First device 105 may be configured to select only the second data that has the pre-registered type, and to transmit the selected second data to second device 110. For another example, first device 105 may be configured to pre-register a condition that second data is to be selected and transmitted to second device 110 only when a predefined object is included in the second data. First device 105 may be configured to select only the second data that has the predefined object, and to transmit the selected second data to second device 110.

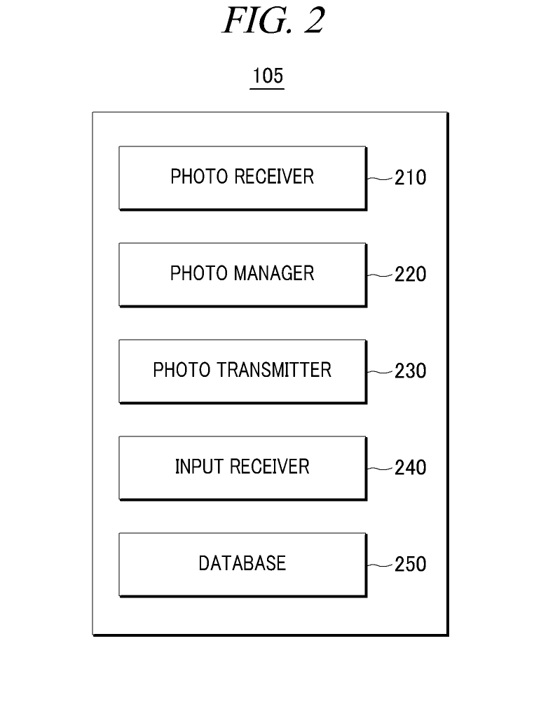

FIG. 2 shows a block diagram of an example architecture for a device that may implement at least portions of a data exchange, arranged in accordance with at least some embodiments described herein. As depicted in FIG. 2, for example, first device 105 may include a photo receiver 210, a photo manager 220, a photo transmitter 230, an input receiver 240 and a database 250. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In that regard, one or more of photo receiver 210, photo manager 220, photo transmitter 230 and input receiver 240 may be included in an instance of an application hosted on first device 105 or second device 110.

Photo receiver 210 may be configured to receive a first photo from second device 110 via network 100. In some embodiments, second device 110 may include a cloud datacenter. In some embodiments, photo receiver 210 may be further configured to receive, from second device 110, metadata that corresponds to the first photo. For example, but not as a limitation, the metadata corresponding to the first photo may refer to a tag of the first photo. The tag of the first photo may be data that provides information about one or more aspects of the first photo, such as means of creation of the first photo, location of creation of the first photo, time and date of creation of the first photo, a creator or author of the first photo, etc. For example, the metadata may include at least one of a time at which the first photo was taken by second device 110 or a location (e.g., coordinates of the location) at which the first photo was taken by second device 110.

Photo manager 220 may be configured to extract data that corresponds to the first photo received from second device 110. In some embodiments, photo manager 220 may be configured to extract the data corresponding to the first photo based on the received metadata that corresponds to the first photo. The data corresponding to the first photo may include information that may be a part of, or the same as, information included in the metadata of the first photo (e.g., the tag of the first photo). For example, but not as a limitation, photo manager 220 may be configured to extract and obtain the data including the time at which the first photo was taken by second device 110, the coordinates of the location at which the first photo was taken by second device 110, etc.

In some other embodiments, photo manager 220 may be configured to recognize an object included in the first photo. For example, photo manager 220 may be configured to identify and/or recognize an identity of an object that appears in the first photo received from second device 110 by using any well-known object recognition schemes. Photo manager 220 may be configured to then extract and obtain the data regarding the recognized object included in the first photo. For example, the data regarding the recognized object may include an image of the recognized object, a unique identifier assigned to the recognized object, etc. As non-limiting examples, the recognized object that appears in the first photo received from second device 110 may include a face of a person.

Photo manager 220 may be configured to select a second photo to which the extracted data corresponds. In some embodiments, photo manager 220 may be configured to select the second photo from database 250 that stores multiple photos. Alternatively, photo manager 220 may be configured to select and receive the second photo from cloud datacenter 115.

In some embodiments, photo manager 220 may be configured to calculate a time difference between the time at which the first photo was taken by second device 110 and a time at which the second photo was taken by first device 105. Further, photo manager 220 may be configured to determine a correspondence between the first photo and the second photo based on the calculated time difference. Photo manager 220 may be configured to select the second photo that is associated with the extracted data regarding the first photo, based at least in part on the calculated time difference. For example, photo manager 220 may be configured to determine whether the calculated time difference is within a predetermined time value stored in a memory of first device 105. Photo manager 220 may be configured to then select the second photo, when the calculated time difference is determined to be within the predetermined time value. For example, photo manager 220 may be configured to select the second photo, if photo manager 220 determines that the first photo and the second photo are taken within one day or one week.

In some other embodiments, photo manager 220 may be configured to calculate a distance difference between the location at which the first photo was taken by second device 110 and a location at which the second photo was taken by first device 105. For example, photo manager 220 may be configured to calculate the distance difference based on coordinates of a location at which the second photo was taken by first device 110 and the coordinates of the location at which the first photo was taken by second device 110, and to determine how far away each of the first photo and second photo was taken. Further, photo manager 220 may be configured to determine a correspondence between the first photo and the second photo based on the calculated distance difference. Photo manager 220 may be configured to select the second photo that is associated with the extracted data regarding the first photo, based at least in part on the calculated distance difference. For example, photo manager 220 may be configured to determine whether the calculated distance difference is within a predetermined distance stored in a memory of first device 105. Photo manager 220 may be configured to then select the second photo, when the calculated distance difference is determined to be within the predetermined distance. For example, photo manager 220 may be configured to select the second photo, if photo manager 220 determines that the first photo and the second photo are taken at the same place.

In some other embodiments, photo manager 220 may be configured to identify an object included in the second photo by using any well-known object recognition schemes. Further, photo manager 220 may be configured to determine a correspondence between the first photo and the second photo based on the identified object and the extracted information regarding the recognized object included in the first photo. For example, photo manager 220 may be configured to calculate a similarity between the recognized object in the first photo and the identified object in the second photo. Further, photo manager 220 may be configured to determine the correspondence between the first photo and the second photo based on the calculated similarity. Photo manager 220 may be configured to select the second photo that is associated with the extracted data regarding the first photo, based at least in part on the calculated similarity. For example, photo manager 220 may be configured to determine whether the calculated similarity is greater than a predetermined value stored in a memory of first device 105. Photo manager 220 may be configured to then select the second photo, when the calculated similarity is determined to be greater than the predetermined value. For example, photo manager 220 may be configured to select the second photo, if photo manager 220 determines that the first photo and the second photo include the same object.

In some other embodiments, photo manager 220 may be configured to calculate a similarity between the recognized facial image of the person in the first photo and a facial image of a person captured in the second photo. Further, photo manager 220 may be configured to select the second photo that is associated with the extracted data regarding the first photo, based at least in part on the calculated similarity. For example, photo manager 220 may be configured to determine whether the calculated similarity is greater than a predetermined value stored in a memory of first device 105. Photo manager 220 may be configured to then select the second photo when the calculated similarity is determined to be greater than the predetermined value. For example, photo manager 220 may be configured to select the second photo, if photo manager 220 determines that a same person appears in both of the first photo and the second photo.

In some embodiments, photo transmitter 230 may be configured to transmit the selected second photo to second device 110 from which photo receiver 210 received the first photo. In some other embodiments, photo transmitter 230 may be configured to transmit the selected second photo to a storage that is associated with second device 110. For example, the storage associated with second device 110 may be a local storage of second device 110. Alternatively, the storage associated with second device 110 may be a cloud datacenter which may be communicatively coupled to second device 110.

Input receiver 240 may be configured to receive an input to control an operation of at least one of photo manager 220 or photo transmitter 230. For example, but not as a limitation, input receiver 240 may be configured to receive, from a user of first device 105 via a user interface displayed on first device 105, an input to determine whether to activate or deactivate functions to select and transmit the second photo.

Database 250 may be configured to store multiple photos including the second photo and the first photo received from second device 110. Further, database 250 may be configured to store metadata that corresponds to the second photo. For example, but not as a limitation, the metadata corresponding to the second photo may include the time at which the second photo was taken by first device 105, the location (e.g., the coordinates of the location) at which the second photo was taken by first device 105, etc. Further, database 250 may be configured to store the metadata that corresponds to the first photo, which is received from second device 110.

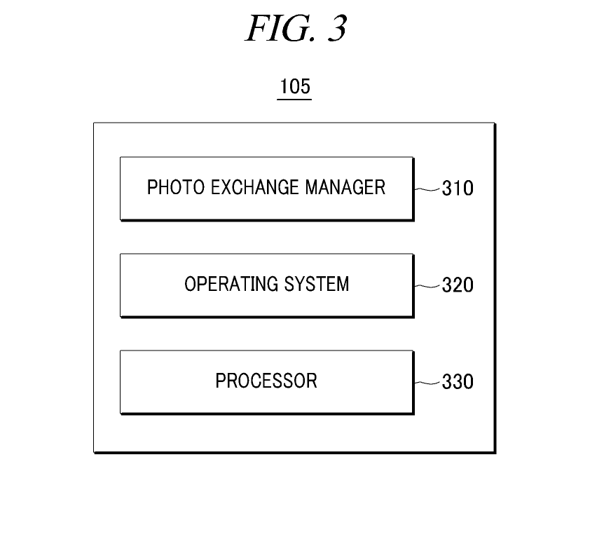

FIG. 3 shows a block diagram of another example architecture for a device that may implement at least portions of a data exchange, arranged in accordance with at least some embodiments described herein. As depicted in FIG. 3, for example, first device 105 may include a photo exchange manager 310, an operating system 320 and a processor 330. Photo exchange manager 310 may be an application adapted to operate on operating system 320 such that may be configured to facilitate the exchange of photos as described herein. Operating system 320 may allow photo exchange manager 310 to manipulate processor 330 to implement the schemes for exchanging photos as described herein.

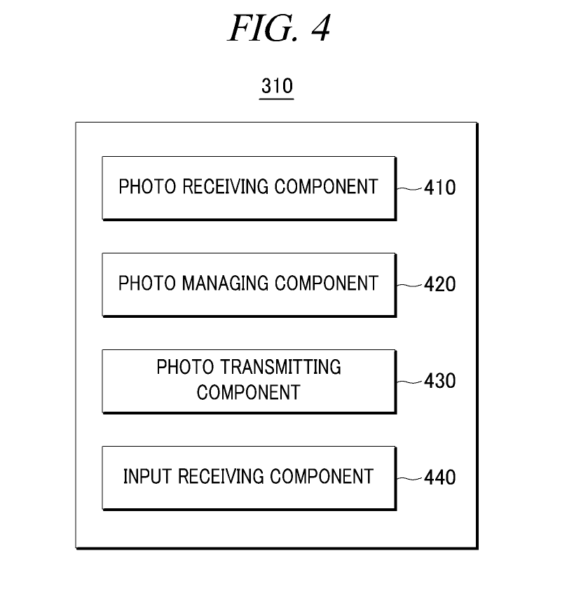

FIG. 4 shows a block diagram of an example architecture for a photo exchange manager 310 that may implement at least portions of a data exchange, arranged in accordance with at least some embodiments described herein. As depicted in FIG. 4, photo exchange manager 310 may include a photo receiving component 410, a photo managing component 420, a photo transmitting component 430 and an input receiving component 450.

Photo receiving component 410 may be configured to receive a first photo from second device 110 via network 100. In some embodiments, photo receiving component 410 may be further configured to receive, from second device 110, metadata that corresponds to the first photo. For example, but not as a limitation, the metadata corresponding to the first photo may refer to a tag of the first photo. The tag of the first photo may be data that provides information about one or more aspects of the first photo, such as means of creation of the first photo, location of creation of the first photo, time and date of creation of the first photo, a creator or author of the first photo, etc. For example, the metadata corresponding to the first photo may include at least one of a time at which the first photo was taken by second device 110, a location (e.g., coordinates of the location) at which the first photo was taken by second device 110, etc.

Photo managing component 420 may be configured to extract data that corresponds to the first photo received from second device 110. In some embodiments, photo managing component 420 may be configured to extract the data corresponding to the first photo based on the received metadata that corresponds to the first photo. For example, but not as a limitation, photo managing component 420 may be configured to extract and obtain the data including the time at which the first photo was taken by second device 110, the coordinates of the location at which the first photo was taken by second device 110, etc.

In some other embodiments, photo managing component 420 may be configured to recognize an object included in the first photo. For example, photo managing component 420 may be configured to identify and/or recognize an identity of an object that appears in the first photo received from second device 110 by using any well-known object recognition schemes. Photo managing component 420 may be configured to then extract and obtain the data regarding the recognized object included in the first photo. For example, the data regarding the recognized object may include an image of the recognized object, a unique identifier assigned to the recognized object, etc. For another example, photo managing component 420 may be configured to recognize a facial image of a person that appears in the first photo received from second device 110 by using any well-known facial image recognition schemes. Further, photo managing component 420 may be configured to identify and/or recognize an identity of the person in the first photo. Photo managing component 420 may be configured to then extract and obtain the data regarding the person or the facial image of the person included in the first photo. For example, the data regarding the person may include the facial image of the person, a unique identifier (e.g., a name) assigned to the person, etc.

Photo managing component 420 may be configured to select a second photo to which the extracted data corresponds. In some embodiments, photo managing component 420 may be configured to select the second photo from a local photo database that stores multiple photos. Alternatively, photo managing component 420 may be configured to select and receive the second photo from cloud datacenter 115.

In some embodiments, photo managing component 420 may be configured to calculate a time difference between the time at which the first photo was taken by second device 110 and a time at which the second photo was taken by first device 105. Further, photo managing component 420 may be configured to determine a correspondence between the first photo and the second photo based on the calculated time difference. Photo managing component 420 may be configured to select the second photo that is associated with the extracted data regarding the first photo, based at least in part on the calculated time difference. For example, photo managing component 420 may be configured to determine whether the calculated time difference is within a predetermined time value stored in a memory of first device 105. Photo managing component 420 may be configured to then select the second photo, when the calculated time difference is determined to be within the predetermined time value. For example, photo managing component 420 may be configured to select the second photo, if photo managing component 420 determines that the first photo and the second photo are taken within one day or one week.

In some other embodiments, photo managing component 420 may be configured to calculate a distance difference between the location at which the first photo was taken by second device 110 and a location at which the second photo was taken by first device 105. For example, photo managing component 420 may be configured to calculate the distance difference based on coordinates of a location at which the second photo was taken by first device 110 and the coordinates of the location at which the first photo was taken by second device 110, and to determine how far away each of the first photo and second photo was taken. Further, photo managing component 420 may be configured to determine a correspondence between the first photo and the second photo based on the calculated distance difference. Photo managing component 420 may be configured to select the second photo that is associated with the extracted data regarding the first photo, based at least in part on the calculated distance difference. For example, photo managing component 420 may be configured to determine whether the calculated distance difference is within a predetermined distance stored in a memory of first device 105. Photo managing component 420 may be configured to then select the second photo, when the calculated distance difference is determined to be within the predetermined distance. For example, photo managing component 420 may be configured to select the second photo, if photo managing component 420 determines that the first photo and the second photo are taken at the same place.

In some other embodiments, photo managing component 420 may be configured to identify an object included in the second photo by using any well-known object recognition schemes. Further, photo managing component 420 may be configured to determine a correspondence between the first photo and the second photo based on the identified object and the extracted information regarding the recognized object included in the first photo. For example, photo managing component 420 may be configured to calculate a similarity between the recognized object in the first photo and the identified object in the second photo. Further, photo managing component 420 may be configured to determine the correspondence between the first photo and the second photo based on the calculated similarity. Photo managing component 420 may be configured to select the second photo that is associated with the extracted data regarding the first photo, based at least in part on the calculated similarity. For example, photo managing component 420 may be configured to determine whether the calculated similarity is greater than a predetermined value stored in a memory of first device 105. Photo managing component 420 may be configured to then select the second photo, when the calculated similarity is determined to be greater than the predetermined value. For example, photo managing component 420 may be configured to select the second photo, if photo managing component 420 determines that the first photo and the second photo include the same object.

In some other embodiments, photo managing component 420 may be configured to calculate a similarity between the recognized facial image of the person in the first photo and a facial image of a person captured in the second photo. Further, photo managing component 420 may be configured to select the second photo that is associated with the extracted data regarding the first photo, based at least in part on the calculated similarity. For example, photo managing component 420 may be configured to determine whether the calculated similarity is greater than a predetermined value stored in a memory of first device 105. Photo managing component 420 may be configured to then select the second photo when the calculated similarity is determined to be greater than the predetermined value. For example, photo managing component 420 may be configured to select the second photo, if photo managing component 420 determines that a same person appears in both of the first photo and the second photo.

In some embodiments, photo transmitting component 430 may be configured to transmit the second photo selected by photo managing component 420 to second device 110 which transmitted the first photo to first device 105. In some other embodiments, photo transmitting component 430 may be configured to transmit the second photo to a local storage of second device 110 or a cloud datacenter which may be communicatively coupled to second device 110.

Input receiving component 440 may be configured to receive an input to control an operation of at least one of photo managing component 420 or photo transmitting component 430. For example, but not as a limitation, input receiving component 440 may be configured to receive, from a user of first device 105 via a user interface displayed on first device 105, an input to determine whether to activate or deactivate functions to select and transmit the second photo.

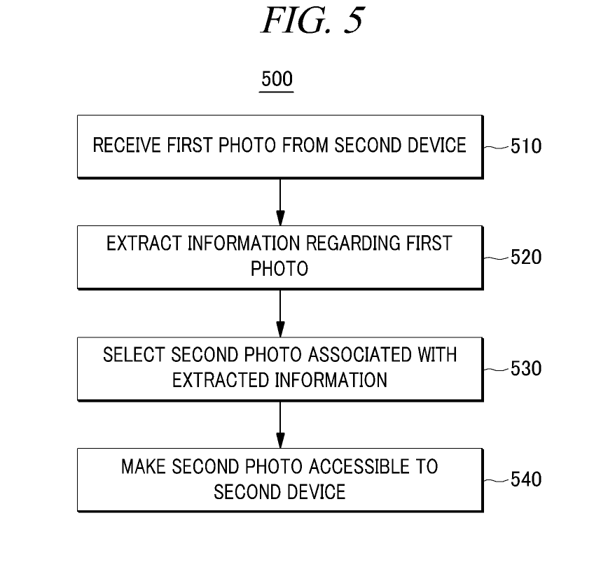

FIG. 5 shows an example flow of a process 500 for exchanging photos between multiple sourcing devices, arranged in accordance with at least some embodiments described herein. The method in FIG. 5 may be implemented in data exchanging environment 10 including first device 105, second device 110 and cloud datacenter 115, as illustrated in FIG. 1. An example process may include one or more operations, actions, or functions as illustrated by one or more blocks 510, 520, 530 and/or 540. Although illustrated as discrete blocks, various blocks may be divided into additional blocks, combined into fewer blocks, or eliminated, depending on the desired implementation. Processing may begin at block 510.

At block 510 (Receive First Photo from Second Device), first device 105 may receive a first photo from second device 110. In some embodiments, at block 510, the first photo may be accompanied by metadata that corresponds to the first photo. For example, but not as a limitation, the metadata corresponding to the first photo may refer to a tag of the first photo. The tag of the first photo may be data that provides information about one or more aspects of the first photo, such as means of creation of the first photo, location of creation of the first photo, time and date of creation of the first photo, a creator or author of the first photo, etc. For example, the metadata may include at least one of a time at which the first photo was taken by second device 110 or a location (e.g., coordinates of the location) at which the first photo was taken by second device 110. Processing may proceed from block 510 to block 520.

At block 520 (Extract Information regarding First Photo), first device 105 may extract information regarding the first photo received at block 510. In some embodiments, first device 105 may extract the information regarding the first photo based on the metadata received at block 510. For example, but not as a limitation, first device 105 may extract and obtain the information including the time at which the first photo was taken by second device 110, the coordinates of the location at which the first photo was taken by second device 110, etc.

In some other embodiments, at block 520, first device 105 may recognize an object included in the first photo by using any well-known object recognition schemes. Then, first device 105 may extract and obtain the information regarding the recognized object included in the first photo. For example, the information regarding the recognized object may include an image of the recognized object, a unique identifier assigned to the recognized object, etc. As non-limiting examples, the recognized object that appears in the first photo received from second device 110 may include a face of a person. Processing may proceed from block 520 to block 530.

At block 530 (Select Second Photo Associated with Extracted Information), first device 105 may select a second photo that is associated with the information regarding the first photo, which is extracted at block 520. First device 105 may select and receive the second photo from among multiple photos stored in a storage that is associated with first device 105. In some embodiments, the storage associated with first device 105 may be a local photo database on first device 105. In some other embodiments, the storage associated with first device 105 may be cloud datacenter 115.

In some embodiments, at block 530, first device 105 may calculate a time difference between the time at which the first photo was taken by second device 110 and a time at which the second photo was taken by first device 105. Further, first device 105 may determine a correspondence between the first photo and the second photo based on the calculated time difference. First device 105 may select the second photo that is associated with the extracted information regarding the first photo, based at least in part on the calculated time difference. For example, first device 105 may determine whether the calculated time difference is within a predetermined time value stored in a memory of first device 105. First device 105 may select the second photo, when the calculated time difference is determined to be within the predetermined time value. For example, first device 105 may select the second photo, if first device 105 determines that the first photo and the second photo are taken within one day or one week.

In some other embodiments, at block 530, first device 105 may calculate a distance difference between the location at which the first photo was taken by second device 110 and a location at which the second photo was taken by first device 105. For example, first device 105 may calculate the distance difference based on coordinates of a location at which the second photo was taken by first device 110 and the coordinates of the location at which the first photo was taken by second device 110, and to determine how far away each of the first photo and second photo was taken. Further, first device 105 may determine a correspondence between the first photo and the second photo based on the calculated distance difference. First device 105 may select the second photo that is associated with the extracted information regarding the first photo, based at least in part on the calculated distance difference. For example, first device 105 may determine whether the calculated distance difference is within a predetermined distance stored in a memory of first device 105. First device 105 may select the second photo, when the calculated distance difference is determined to be within the predetermined distance. For example, first device 105 may select the second photo, if first device 105 determines that the first photo and the second photo are taken at the same place.

In some other embodiments, at block 530, first device 105 may identify an object included in the second photo by using any well-known object recognition schemes. Further, first device 105 may determine a correspondence between the first photo and the second photo based on the identified object and the extracted information regarding the recognized object included in the first photo. For example, first device 105 may calculate a similarity between the recognized object in the first photo and the identified object in the second photo. Further, first device 105 may determine the correspondence between the first photo and the second photo based on the calculated similarity. First device 105 may select the second photo that is associated with the extracted information regarding the first photo, based at least in part on the calculated similarity. For example, first device 105 may determine whether the calculated similarity is greater than a predetermined value stored in a memory of first device 105. First device 105 may select the second photo, when the calculated similarity is determined to be greater than the predetermined value. For example, first device 105 may select the second photo, if first device 105 determines that the first photo and the second photo include the same person. Processing may proceed from block 530 to block 540.

At block 540 (Make Second Photo Accessible to Second Device), first device 105 may make the second photo, which is selected at block 530, accessible to second device 110 from which first device 105 received the first photo at block 510. In some embodiments, first device 105 may transmit the second photo to second device 110. In some other embodiments, first device 105 may transmit the second photo to a storage that is associated with second device 110. For example, the storage associated with second device 110 may be a local storage of second device 110. Alternatively, the storage associated with second device 110 may be a cloud datacenter (e.g., cloud datacenter 115) which may be communicatively coupled to second device 110.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

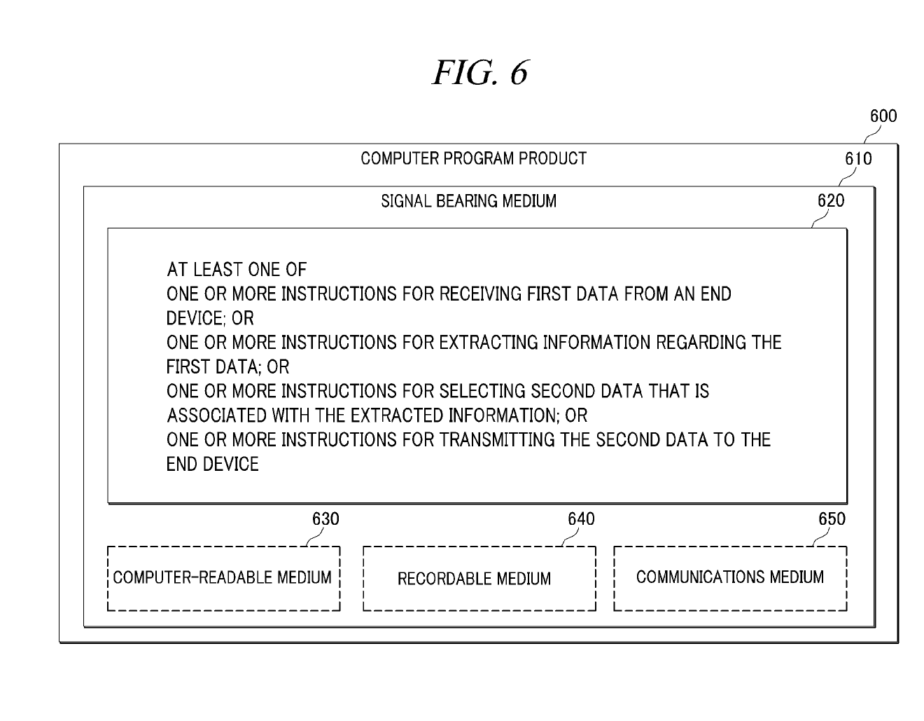

FIG. 6 illustrates computer program products that may be utilized to provide a scheme for exchanging data between multiple sourcing devices, arranged in accordance with at least some embodiments described herein. Program product 600 may include a signal bearing medium 610. Signal bearing medium 610 may include one or more instructions 620 that, when executed by, for example, a processor, may provide the functionality described above with respect to FIGS. 1-5. By way of example, but not limitation, instructions 620 may include: one or more instructions for receiving first data from an end device; one or more instructions for extracting information regarding the first data; one or more instructions for selecting second data that is associated with the extracted information; or one or more instructions for transmitting the second data to the end device. Thus, for example, referring to FIG. 5, first device 105 may undertake one or more of the blocks shown in FIG. 5 in response to instructions 620.

In some implementations, signal bearing medium 610 may encompass a computer-readable medium 630, such as, but not limited to, a hard disk drive, a CD, a DVD, a digital tape, memory, etc In some implementations, signal bearing medium 610 may encompass a recordable medium 640, such as, but not limited to, memory, read/write (R/W) CDs, R/W DVDs, etc In some implementations, signal bearing medium 610 may encompass a communications medium 650, such as, but not limited to, a digital and/or an analog communication medium (e.g., a fiber optic cable, a waveguide, a wired communications link, a wireless communication link, etc). Thus, for example, program product 600 may be conveyed to one or more modules of first device 105 by an RF signal bearing medium 610, where the signal bearing medium 610 is conveyed by a wireless communications medium 650 (e.g., a wireless communications medium conforming with the IEEE 802.11 standard).

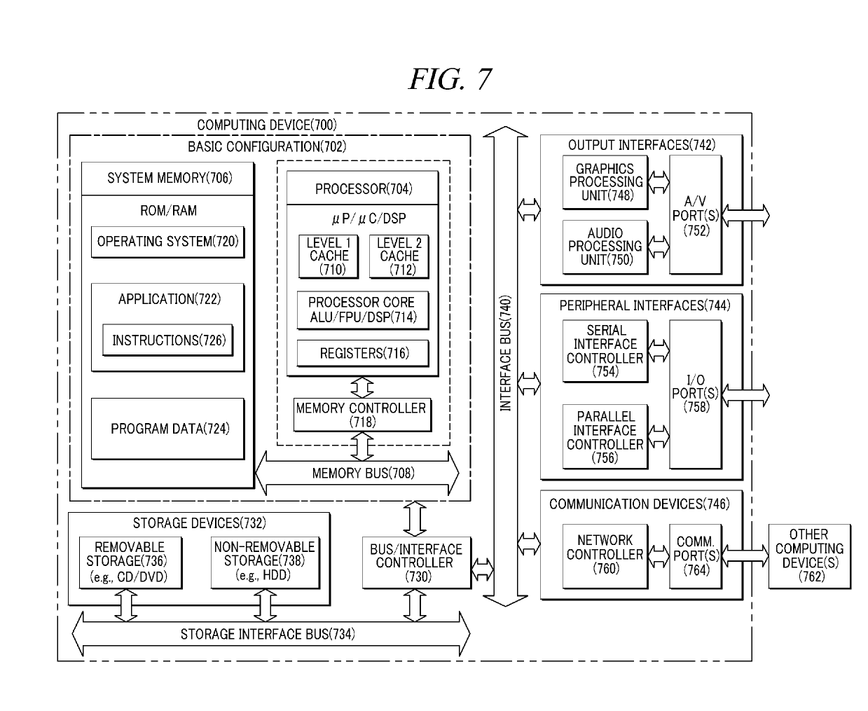

FIG. 7 is a block diagram illustrating an example computing device that may be utilized to provide a scheme for exchanging data, arranged in accordance with at least some embodiments described herein. In these examples, elements of computing device 700 may be arranged or configured for a device. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc) or any combination thereof. System memory 706 may include an operating system 720, an application 722, and program data 724. Application 722 may include instructions 726 that may be arranged to perform the functions as described herein including the actions described with respect to first device architecture as shown in FIG. 2 or including the actions described with respect to the flow charts shown in FIG. 5. In some examples, application 722 may be arranged to operate with program data 724 on an operating system 720 such that the schemes for exchanging data as described herein may be provided.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc) or other peripheral devices (e.g., printer, scanner, etc) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc). In those instances where a convention analogous to “at least one of A, B, or C, etc” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc As a non-limiting example, each range discussed herein can be readily broken down into a lower third, middle third and upper third, etc As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a first device, comprising:
receiving a first photo from a second device;
extracting information regarding the first photo;
selecting a second photo that is associated with the extracted information from among a plurality of photos, wherein the plurality of photos is generated by the first device; and
making the second photo accessible to the second device.

2. The method of claim 1, further comprising:
receiving metadata corresponding to the first photo from the second device,
wherein the extracting is based at least in part on the metadata.

3. The method of claim 2, wherein the metadata corresponding to the first photo includes at least one of a time at which the first photo was taken or a location at which the first photo was taken.

4. The method of claim 3, wherein the selecting includes:
determining that a time difference between the time at which the first photo was taken and a time at which the second photo was taken is within a predetermined time value.

5. The method of claim 3, wherein the selecting includes:
determining that a distance between the location at which the first photo was taken and a location at which the second photo was taken is within a predetermined distance.

6. The method of claim 1, wherein the extracting of the information regarding the first photo includes:
recognizing an object in the first photo,
wherein the extracting is based at least in part on the recognized object.

7. The method of claim 6, wherein the selecting includes:
calculating a similarity between the recognized object in the first photo and an object recognized in the second photo; and
determining that the similarity is larger than a predetermined value.

8. The method of claim 1, wherein the extracting of the information regarding the first photo includes:
recognizing a facial image of a person captured in the first photo, wherein the selecting includes:
calculating a similarity value between the recognized facial image of the person in the first photo and a facial image of a person captured in the second photo; and
determining that the similarity value is larger than a predetermined value.

9. The method of claim 1, further comprising:
receiving an input that controls at least one of the selecting of the second photo or the transmitting of the second photo.

10. The method of claim 1, wherein the plurality of photos are stored in a cloud datacenter,
wherein the method further comprises receiving, from the cloud datacenter, the second photo that is associated with the extracted information.

11. The method of claim 1, wherein the second device is a cloud data center storing a plurality of photos including the first photo.

12. The method of claim 1, wherein the making the second photo accessible to the second device comprises transmitting the second photo to a storage associated with the second device.

13. (canceled)

14. (canceled)

15. (canceled)

16. (canceled)

17. The method of claim 15, wherein the storage associated with the first device is a cloud datacenter.

18. A photo exchange apparatus, comprising:
a photo receiver configured to receive a photo from an end device;
a photo manager configured to:
extract data corresponding to the received photo, and
select a second photo to which the extracted data corresponds, wherein the second photo is generated by the photo exchange apparatus; and
a photo transmitter configured to transmit the second photo to the end device.

19. The photo exchange apparatus of claim 18, wherein the photo manager is configured to select the second photo from a local photo database.

20. The photo exchange apparatus of claim 18, wherein the photo receiver is further configured to receive metadata corresponding to the photo from the end device, and
wherein the photo manager is further configured to extract the data corresponding to the received photo based at least in part on the metadata.

21. The photo exchange apparatus of claim 20, wherein the metadata corresponding to the photo includes at least one of a time at which the photo was taken by the end device or a location at which the photo was taken by the end device.

22. The photo exchange apparatus of claim 21, wherein the photo manager selects the second photo by:
calculating a time difference between the time at which the photo was taken by the end device and a time at which the second photo was taken by the photo exchange apparatus, and
determining that the time difference is within a predetermined time value.

23. The photo exchange apparatus of claim 21, wherein the photo manager selects the second photo by:
calculating a distance between the location at which the photo was taken by the end device and a location at which the second photo was taken by the photo exchange apparatus; and
determining that the calculated distance is within a predetermined distance.

24. The photo exchange apparatus of claim 18, wherein the photo manager is further configured to recognize an object in the photo, and
wherein the photo manager extracts the data based at least in part on the recognized object.

25. The photo exchange apparatus of claim 24, wherein the photo manager selects the second photo by:
calculating a similarity between the recognized object in the photo and an object recognized in the second photo; and
determining that the similarity is larger than a predetermined value.

26. (canceled)

27. (canceled)

28. A computer-readable storage medium having stored thereon computer-executable instructions that, in response to execution, cause a device to perform operations, comprising:
receiving first data from an end device;
extracting information regarding the first data;
selecting second data that is associated with the extracted information, wherein the second data is generated by the device; and
transmitting the second data to the end device.

29. The computer-readable storage medium of claim 28, wherein the first data includes at least one of a photo, a video file, or an audio file, and
wherein the second data includes at least one of a photo, a video file, or an audio file.

30. The computer-readable storage medium of claim 28, wherein the operations further comprise:
receiving metadata corresponding to the first data from the end device,
wherein the extracting is based at least in part on the metadata,
wherein the metadata corresponding to the first data includes at least one of a time at which the first data was generated by the end device or a location at which the first data was generated by the end device.

31. The computer-readable storage medium of claim 30, wherein the selecting includes:
determining that a time difference between the time at which the first data was generated by the end device and a time at which the second data was generated by the device is within a predetermined time value.

32. The computer-readable storage medium of claim 30, wherein the selecting includes:
determining that a distance between the location at which the first data was generated by the end device and a location at which the second data was generated by the device is within a predetermined distance.
